(19) United States
(12) Patent Application Publication
(10) Pub. No.: US 2008/0082822 A1
(43) Pub. Date: Apr. 3, 2008

(54) Encrypting/decrypting units having symmetric keys and methods of using same

(76) Inventor: Charles Rodney Starrett, Cary, NC (US)

Correspondence Address: TRIANGLE PATENTS, P.L.L.C., P.O. BOX 28539, RALEIGH, NC, 27611-8539, US

(21) Appl. No.: 11/529,817

(22) Filed: Sep. 29, 2006

(51) Int. Cl. H04L 9/00

(52) U.S. Cl. 713/171

(57) ABSTRACT

An encrypting/decrypting unit that receives symmetric keys from a key authority point (KAP) within a secure network having a software operating on a management and policy server (MAP) in communication with the KAP for providing key(s) to policy enforcement points (PEPs) on the network.

### BACKGROUND OF THE INVENTION

1. Field of the Invention

The present invention relates generally to secure communication and/or interaction within a secure network. More particularly, the present invention relates to systems and methods for providing encryption/decryption units that receive common keys to enable load balancing and distributed communication across the network.

2. Description of the Prior Art

Generally, current security solutions for networks include discrete solutions provided by security software and encryption algorithms and keys generated therefrom, network infrastructure, information technology (IT) infrastructure, and other enabling infrastructure, such as those provided by hardware and software for particular applications. Typically, changes to security solutions and even modifications within an existing security solution for a network requires complex adaptation and changes to the existing infrastructure, or are so cumbersome that use of encryption and security throughout most network activity is not commercially feasible or manageable.

Additionally, prior art secure network systems and methods require complex steps and configurations to arrange secure associations for devices to be operable for data access and communication across devices within a secure network. In particular, for establishing a full mesh for secure network communication between a multiplicity of points and corresponding devices, the number of keys required to be distributed is N(N−1) and secure associations 2N(N−1), where N is the number of devices at points within the network. For even a reasonably small network where N is between 10-1000, the configuration and steps required to provide security of communication and data for a full mesh is commercially impractical; this decreases the likelihood that security will be applied and used regularly and widespread across the network. Therefore, security is actually diminished because full mesh is not commercially reasonable to manage and use in the normal course of business for even medium to large networks.

Other prior art key distribution provides for key management for multicasting, such as IPSec policy managers that define gateways within secure networks.

By way of example, current practice for providing secure group communications is represented by US Patent Application Publication No. 2004/0044891 for “System and method for secure group communications” by Hanzlik et al. published on Mar. 4, 2004 relating to implementation of a virtual private network group having a plurality of group nodes, a policy server, and shared keys for sharing encrypted secure communication information among the group nodes.

Thus, there remains a need for a network security solution having simplified, effective key generation and distribution across the network.

### SUMMARY OF THE INVENTION

The present invention provides systems and methods for simplified management of secured networks with distributed keys and management of same from a universal key authority point (KAP) for a data and/or communications network.

A first aspect of the present invention provides a system for management of secure networks including at least one management and policy (MAP) server constructed and configured for communication through a network by pushing policy to at least one key authority point (KAP) on the network, wherein the KAP(s) is operable to generate and distribute keys based upon the policy communicated to the KAP by the MAP, wherein the keys are provided to a multiplicity of policy enforcement point (PEP)s to ensure secure association across PEPs within the network; and wherein at least one encryption/decryption unit is provided with a common key to facilitate load balancing and packet movement through the network.

Another aspect of the present invention provides methods for generating and distributing a common key from the KAP to encryption/decryption units operable on the network to provide movement of at least one packet through at least one PEPs, wherein the keys are generated and distributed from a universal KAP based upon policy according to a MAP server and the common key facilitates load balancing by the units.

In a preferred embodiment, the present invention provides systems and methods for providing a secure network and subnets including at least one management and policy (MAP) server constructed and configured for communication through at least one key authority point (KAP) that generates and distributes keys to policy enforcement points (PEPs) distributed across the network, the KAP generating at least one key according to MAP policy or policies to ensure secure association through the PEPs within the network and at least one common key to encryption/decryption units, wherein the key generation and distribution operation by the KAP are automatic, and wherein the encryption/decryption units function to encrypt and decrypt packets communicated across the network using the common key such that any encryption/decryption unit can decrypt a packet encrypted by any other encryption/decryption unit.

In another embodiment, the present invention provides a high bandwidth capable encryption and decryption apparatus that uses interchangeable encryption/decryption units using common keys to encrypt/decrypt packets to be transmitted over the high bandwidth network.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic of the overall system, in accordance with an embodiment of the present invention.

FIG. 2 is a schematic of a portion of a network having a 10 Gb encryption arrangement according to the present invention.

FIG. 3 is a schematic showing groups of paired encryption/decryption units within a system according to the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

As referred to herein, the term “encryption” includes aspects of authentication, entitlement, data integrity, access control, confidentiality, segmentation, information control, and combinations thereof.

The present invention provides a key and policy management software-based solution that enables secure data access and user interactions, and that enables users to securely access and interact with data they need and are authorized to access on predetermined, regular, and/or transactional bases from any point on the network without requiring changes in the existing infrastructure. The present invention system and method controls and manages the establishment and activity for trusted, secure connections across a network that are created by end point security technologies. This flexible software solution does not require a separate infrastructure to affect changes in network access, key or policy management.

Preferably, the system and methods of the present invention provide a network-independent solution layer or overlay that functions over the existing network infrastructure to control the policies, secure associations (SAs), and keys provided by a universal key authority point (KAP) to a multiplicity of policy enforcement points (PEPs) for enabling secure communications and data access to authorized users at any point within the network to other points, based upon the policies managed and provided by a management and policy server (MAP). The present invention provides for essentially unlimited scalability and address management that is commercially practical to implement network-wide for all secure communication, data access, applications, and devices, regardless of the type or form of encryption used by a particular device or hardware within the network. Also, the flexible software overlay for MAP and KAP functions within the system provides for dynamic modifications in real time without requiring changes to existing infrastructure or hardware, and without regard to the form of encryption thereon. Therefore, use and implementation of the present invention is not limited to traditional networking or infrastructure and is not limited to a single encryption form or type.

The present invention provides a method and a system for automatically securing communication between two or more nodes in a distributed network that use a single shared key or separate keys generated and distributed by at least one key authority point based upon a policy or policies managed by a management and policy server for the entire network, wherein packet encryption and decryption are carried out by encryption/decryption units for load balancing and multicasting using a common key, preferably a symmetric key, provided by the KAP to the units. In preferred embodiments at the time of the present invention, all keys distributed by a KAP are symmetric keys.

The present invention provides for at least one encrypting/decrypting unit that receives symmetric keys from a key authority point (KAP) within a secure network having a software operating on a management and policy server (MAP) in communication with the KAP for providing key(s) to policy enforcement points (PEPs) on the network and at least one common key to encryption/decryption units for facilitating encrypting and decrypting packets and transmitting the packets securely through the network, including load balancing of the encryption/decryption functions and multicasting of the packets. The symmetric key distributed by the KAP is the common key used to encrypt traffic.

In one embodiment of the present invention, each of a multiplicity of encrypting/decrypting units have the same symmetric keys provided by a KAP, wherein any unit is operable to encrypt and/or decrypt a packet. Preferably, during the system start-up for operation, each unit is authenticated, by way of example and not limitation, by IKE and/or certificates for public-private key exchange.

Generally, IPSec encryption today is well defined and leverages IKE for key exchange. Using standard IKE, encryptors in the 10 Gb application could be paired so that the output of one encryptor would always be decrypted by the same peer on the remote side. However, by tying encryptors in matched pairs, resiliency and load sharing algorithms are greatly limited. If either of the paired units fails then a full lgig of bandwidth is lost, which is detrimental to the network functionality. Also, the switching algorithms that distribute traffic across both VLAN and non-VLAN trunks are limited in their function since traffic from one encryptor must always be switched to a specific encryption unit.

A distributed network includes multiple nodes that are interconnected by multiple routers, bridges, etc. and that may be connected in a variety of different network topologies. In a distributed network, a node may be part of a smaller network such as an office LAN, or even a single node directly connected to the internet. The node can be connected to an unprotected network such as the Internet either directly or through a gateway, router, firewall and/or other such devices that allow one or more nodes to connect to a network via a single point. The nodes include computing devices such as, by way of example and not limitation, laptops, desktops, handheld devices, mobile devices, cable access systems, and other devices capable of connecting to a network, or a network of such devices.

These nodes communicate with each other, or servers providing services such as web pages, email, voice over internet protocol (VoIP), video broadcasting, multicasting applications, streaming audio or video via unprotected networks. In certain cases, when the communication is between two nodes that are using the same network, this communication may be protected. However, most of the communication over the internet is unprotected. This means that the communication can be intercepted by anyone. This communication is protected by using cryptographic keys. One or more nodes are grouped together so that they communicate over the unprotected networks via at least one policy enforcement point (PEP). Typically there are several PEPs in a distributed network. The PEPs receives policies from a management and policy server (MAP). The MAP defines the policies that govern the communication of the PEPs and the nodes under the PEPs. There are one or more key authority points (KAP) that communicate with the MAP and generate one or more cryptographic keys for PEPs. There are several configurations operable for arranging PEPs and KAPs within a network according to the present invention. By way of example, the system is operable for multiple KAPs, including peer KAPs, for one or more PEPs. Alternatively, the system and methods are functional where there is a single KAP that provides the keys for all the PEPs in a distributed network.

Based on the policies received from the MAP, the universal KAP of the present invention generates one or more cryptographic keys for each of the PEPs, or a single key to be shared by PEPs, within its network as defined by the MAP. The PEPs use the cryptographic keys to encrypt communication from the nodes and networks that they protect to unprotected networks, decrypt communication from unprotected networks to the nodes and networks that they protect or both. The universal KAP receives the policy definition from a single MAP. This policy definition informs the KAP about the PEPs it is responsible for, which networks the PEPs protect, and which KAP units they use. The KAP distributes the keys and policies associated with its networks and nodes to the appropriate PEPs.

The present invention provides for at least one encrypting/decrypting unit that receives symmetric keys from a key authority point (KAP) within a secure network having a software operating on a management and policy server (MAP) in communication with the KAP for providing key(s) to policy enforcement points (PEPs) on the network.

The original IP address and the original MAC address is maintained for each packet. This enables a completely transparent implementation of encryption and decryption, especially at layer 2. In addition, using the end stations IP and MAC addresses enables a much more balanced load across a link aggregation group. It also allows for the packets to be transmitted across firewalls, routers and the like. For instance, in the 10 Gig encryption system, two switches communicating over a 10 Gig link have encryptors on each side sharing keys to encrypt and decrypt traffic. The switches employ standard link aggregation techniques to distribute traffic over the encryptors.

According to systems and methods of the present invention, multiple units are connected with a router or a switch on each side of a 10 Gb link. More particularly, two ports are provided, including an encrypted port for encrypting plain packets and sending the encrypted plain packets back to the router, and then to be sent to other side of 10 Gb link, and for decrypting a received packet and sending the decrypted received packet back to the router to be forwarded to a local address; and a clear port for sending a plain packet to be encrypted, and for receiving a decrypted packet.

Preferably, each encrypting/decrypting unit has an IP address and the router knows the IP address of each unit connected to the router. This provides for the units to be dynamically added and/or removed from routers so that each router performs a load balancing in deciding to which unit to send a given packet for encryption and/or decryption.

One method for the balancing is by a link aggregation. Another is by a round robin algorithm. Other methods or combinations are also operable for the load balancing according to the present invention.

In one embodiment, the KAP sends cryptographic keys to the PEPs or to peer KAPs based upon the policy communicated to the KAP by the MAP. The keys are encrypted at the universal KAP with an encrypting key, which may include a pre-shared private key. Preferably, the universal KAP includes a secure hardware module that stores the pre-shared private key and encrypts the cryptographic keys. The secure hardware module is tamper-proof and disables access if the KAP is attacked. The use of the secure hardware module prevents exposure of the cryptographic keys in memory or backplane, where they can be accessed in clear text. The secure hardware module's tamper-proof feature enables it to shut down when it detects that it has been removed from the KAP. Hence, during attack, the cryptographic keys cannot be accessed, since they are stored in the secure hardware module which shuts down when it detects attack. Attack can be in the form of removal of the secure hardware module so that its memory can be independently accessed to gain access to the cryptographic key.

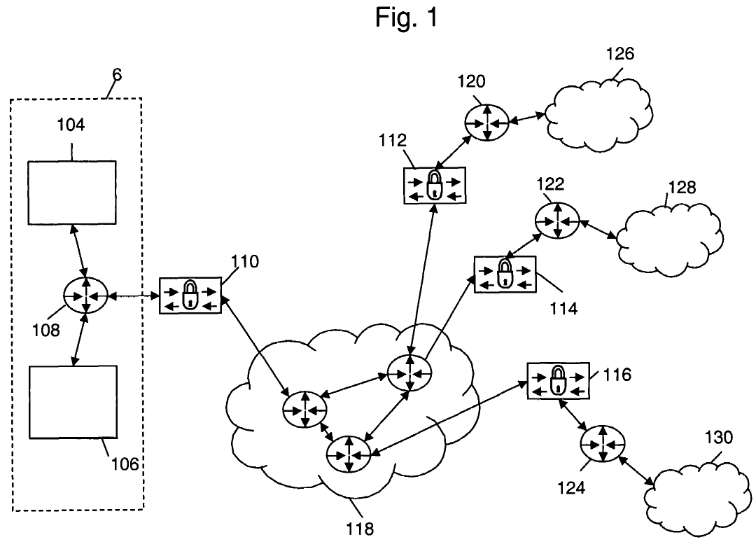

Referring now to the drawings in general, the illustrations are for the purpose of describing a preferred embodiment of the invention and are not intended to limit the invention thereto. As best seen in FIG. 1, a schematic of the overall system, in accordance with an embodiment of the present invention is shown. A management and policy (MAP) server 104 and a key authority point (KAP) 106 are connected to a network node 108. Network node 108 connects to a policy enforcement point (PEP) 110. PEPs 112, 114 and 116 are also connected to PEP 110 via an unprotected network 118. Unprotected network 118 is a network of interconnected nodes and smaller networks, such as the internet or a local LAN or WAN. PEPs 112, 114 and 118 are connected to network nodes 120, 122 and 124 respectively. The network nodes may be individual network points or can be access points to sub-networks 126, 128 and 130. KAP 106 generates and sends keys to PEPs 110, 112, 114 and 116. The keys enable PEPs to encrypt and/or authorize communication between the PEPs 110, 112, 114 and 118 and the nodes behind the PEPs. In an alternate embodiment, MAP 104 and KAP 106 are implemented as programs that reside on network node 108.

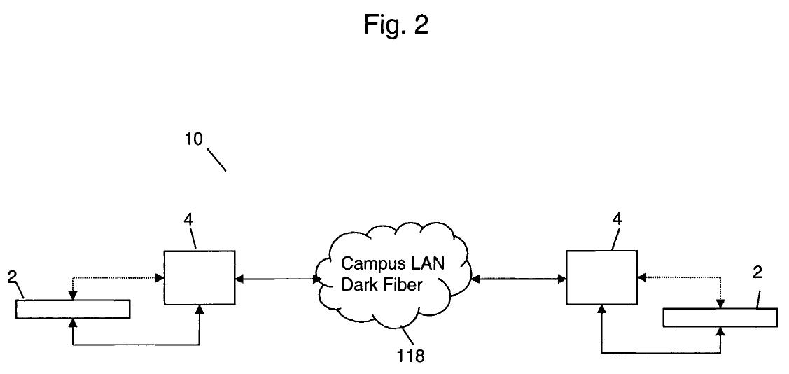

A 10 Gb Ethernet encryption service according to the present invention is established or built using 1 Gig encryptors on the “side” of a 10 Gig switch. FIG. 2 shows the placement of the encryptors (2) and the switches (4) in a 10 Gig environment, generally referenced (10). Any number of encryptors can be configured and are operable to provide sufficient bandwidth to satisfy the switch's needs.

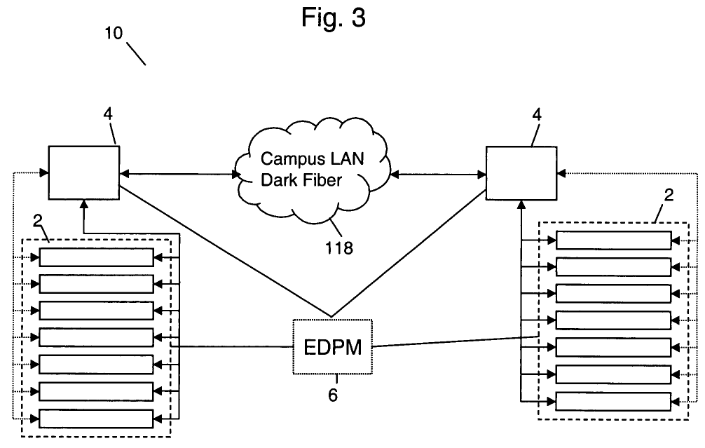

By contrast to prior art, in a preferred embodiment according to the present invention, EDPM technology employs a key authority point (KAP) that alleviates the limitations described above that describe the state of the art. Preferably, with a KAP, IPSec encryptors are grouped together (FIG. 2), sharing keys and other Security Association content. By contrast to the prior art, with the present invention, instead of two units being paired, two groups are paired so that any packet encrypted on one side can be decrypted by any encryption device on the peer side. Units can fail and traffic is limited only by the loss of bandwidth on one side. The switches are operable with any load balancing algorithm, by way of example and not limitation, round robin, address hash, load sharing, etc., to distribute traffic over the encryption devices. As illustrated in FIG. 3, sharing the keys provided by the KAP enables a superior solution to the use of standard IKE in this application.

The present invention also provides a method for providing secure interactivity between points on a network including the steps of: providing a communication network having a network infrastructure and a secure network topography between a multiplicity of policy enforcement points (PEPs) having nodes with any form of encryption associated therewith; a user providing at least one policy definition to a management and policy (MAP) server in communication with a key authority point (KAP); the KAP generating and distributing keys to the PEPs and at least one common key provided to a multiplicity of encryption/decryption units consistent with the MAP policy; the encryption/decryption units performing load balancing on the network to direct packets through routers using the common keys; and the PEPs enforcing the policy at the nodes to provide secure communication across the network topography.

Preferably, multiple encryption/decryption units are connected with a router on each side of a 10 Gb link, with any encryption/decryption unit being operable to encrypt and/or decrypt any packet, and each encrypting/decrypting unit has an IP address and the router knows the IP address of each unit connected to the router.

Also, the system includes two ports, including an encrypted port and a clear port, the ports providing the steps of: the encrypted port encrypting plain packets and sending the encrypted plain packets back to the router, then to other side of the 10 Gb link, and decrypting a received packet and sending the decrypted received packet back to the router to be forwarded to a local address; and the clear port sending a plain packet to be encrypted and for receiving a decrypted packet.

Preferably, the method provides for adding and/or removing units from association with the routers and providing a multiplicity of routers and units connected thereto, including the steps of each router performing a load balancing in deciding to which unit to send a given packet for encryption and/or decryption.

Certain modifications and improvements will occur to those skilled in the art upon a reading of the foregoing description. The above mentioned examples and embodiments are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for providing secure networks comprising:
a communication network having a network infrastructure; and
software operating on a server in connection to the network for providing security for the network; wherein the software provides:
a management and policy (MAP) server coupled to the network for communication with at least one key authority point (KAP), wherein the MAP includes at least one policy for providing secure association (SA) within the network;
wherein the KAP is operable to generate and manage keys communicated to a multiplicity of policy enforcement points (PEPs) having nodes distributed throughout the network, including a common key provided to at least one encryption/decryption unit to facilitate encryption of packets such that encrypted packets can be decrypted by any one of at least one other encryption/decryption unit;
and wherein the network automatically provides a network topography of secure communication based upon the policy and keys distributed to the PEPs for any encryption form at the nodes, thereby providing a secure, flexible network security solution.

2. The system of claim 1, wherein the KAP is operable to reconfigure secure PEP interactivity without requiring change to the network infrastructure.

3. The system of claim 1, wherein the at least encryption/decryption unit enables high bandwidth encryption/decryption over a high bandwidth network.

4. The system of claim 1, wherein the common key is symmetrical.

5. The system of claim 1, wherein any encryption/decryption unit is operable to encrypt and/or decrypt any packet.

6. The system of claim 1, wherein multiple encryption/decryption units are connected with a router on each side of a 10 Gb link and wherein any encryption/decryption unit is operable to encrypt and/or decrypt any packet.

7. The system of claim 6, further including two ports, including an encrypted port and a clear port.

8. The system of claim 7, wherein the encrypted port is operable for encrypting plain packets and sending the encrypted plain packets back to the router, then to other side of the 10 Gb link, and for decrypting a received packet and sending the decrypted received packet back to the router to be forwarded to a local address; and the clear port is operable for sending a plain packet to be encrypted and for receiving a decrypted packet.

9. The system of claim 6, wherein each encrypting/decrypting unit has an IP address and the router knows the IP address of each unit connected to the router.

10. The system of claim 6, wherein the units are configured to be dynamically added and/or removed from routers.

11. The system of claim 6, further including a multiplicity of routers and units connected thereto so that each router performs a load balancing in deciding to which unit to send a given packet for encryption and/or decryption.

12. The system of claim 11, wherein the load balancing is performed by link aggregation.

13. The system of claim 11, wherein the load balancing is provided according to a round robin algorithm.

14. The system of claim 1, wherein the KAP is operable to communicate key(s) and policy to peer KAP(s).

15. A method for providing secure interactivity between points on a network comprising the steps of:
providing a communication network having a network infrastructure and a secure network topography between a multiplicity of policy enforcement points (PEPs) having nodes with any form of encryption associated therewith;
a user providing at least one policy definition to a management and policy (MAP) server in communication with a key authority point (KAP);
the KAP generating and distributing keys to the PEPs and at least one common key provided to a multiplicity of encryption/decryption units consistent with the MAP policy;
the encryption/decryption units encryption of packets to be transmitted on the network through routers using the common keys so that any other encryption/decryption units can decrypt the packets; and
the PEPs enforcing the policy at the nodes to provide secure communication across the network topography.

16. The method of claim 15, wherein multiple encryption/decryption units are connected with a router on each side of a 10 Gb link, any encryption/decryption unit being operable to encrypt and/or decrypt any packet.

17. The method of claim 15, further including two ports, including an encrypted port and a clear port, the ports providing the steps of:
the encrypted port encrypting plain packets and sending the encrypted plain packets back to the router, then to other side of the 10 Gb link, and decrypting a received packet and sending the decrypted received packet back to the router to be forwarded to a local address;
and the clear port sending a plain packet to be encrypted and for receiving a decrypted packet.

18. The method of claim 15, wherein each encrypting/decrypting unit has an IP address and the router knows the IP address of each unit connected to the router.

19. The method of claim 15, further including the step of adding or removing units from association with the routers.

20. The method of claim 19, further including a multiplicity of routers and units connected thereto, including the steps of each router performing a load balancing in deciding to which unit to send a given packet for encryption and/or decryption.
